(19) United States
(12) Patent Application Publication
(10) Pub. No.: US 2012/0047083 A1
(43) Pub. Date: Feb. 23, 2012

(54) Fire Situation Awareness And Evacuation Support

(76) Inventors: Lifeng Qiao, Beijing (CN); Hui Zhang, Beijing (CN); Rui Yang, Beijing (CN); Yanyan Chu, Guangzhou (CN); Shaodong Guo, Beijing (CN); Hengtao Wang, Beijing (CN); Qingshan Jia, Beijing (CN); Qianchuan Zhao, Beijing (CN); Yi Jiang, Beijing (CN); Satish Narayanan, Ellington, CT (US)

(21) Appl. No.: 13/211,465

(22) Filed: Aug. 17, 2011

(30) Foreign Application Priority Data
Aug. 18, 2010 (CN) 201010257243.5

(51) Int. Cl. G06Q 99/00

(52) U.S. Cl. 705/325

(57) ABSTRACT

A building fire situation awareness and evacuation support system includes a plurality of fire monitoring devices for monitoring development of a fire; a plurality of occupant monitoring devices for monitoring occupant distribution in different zones of the building; and a computation device in communication with the fire monitoring devices and occupant monitoring devices, the computation device estimating fire source location and a fire development trend in response to the fire monitoring devices and estimating occupant distributions in different zones of the building in response to the plurality of occupant monitoring devices; the computation device generating an evacuation strategy for occupants in response to the fire monitoring devices, occupant monitoring devices, estimated fire source location, estimated fire development trends, estimated occupant distributions and building structure information; wherein the evacuation strategy includes evacuation routes or evacuation directions.

### BACKGROUND OF THE INVENTION

Embodiments of the invention relate to fire safety systems for buildings, and in particular relate to methods and systems for fire situation assessment and evacuation guidance.

In current buildings, especially in large buildings with complicated structures, fire alarm and evacuation indication systems are common, and can help to avoid injuries, deaths and property losses. Improvements to traditional fire alarm and evacuation guidance systems, in which evacuation indicators are static signs pointing to exits, would be well received in the art.

Traditional evacuation guidance systems include static systems, which cannot adapt to changes in the fire event. For example, as a fire progresses, some evacuation routes can become blocked by fire or smoke. In systems using static evacuation indicators, there is a risk that people will be guided towards these blocked routes. Chinese patent application publication number CN101079178A, entitled “A Fire Alarm Control System”, discloses using fire alarm signals to adjust an evacuation plan adaptively. However, since the fire alarm information only includes early stage fire information, such as where and when the alarm started, using the limited fire alarm information may produce faulty guidance.

In traditional static evacuation guidance systems, occupant information cannot be integrated into the evacuation indication system, and may cause an inefficient evacuation. Usually, in current buildings, the fire safety system and the building security system are separate systems. Occupant information is acquired within the security system such as an access control system, video surveillance system, etc. Integration of occupant information into the fire alarm and evacuation control system is rare, so there are few ways to use occupant location as an additional information source in the evacuation guidance system in traditional systems. Chinese patent application publication number CN1783154A, entitled “Intelligent Evacuation Guidance System” and Chinese patent application publication number CN1783154A, entitled “Evacuation System with Guidance Light” disclose some dynamic guidance hardware with the fire alarm system, however, neither considers the impact of occupant information, such as congestion, on the evacuation efficiency.

In traditional fire alarm and evacuation guidance systems, there is no approach to integrate fire sensing information and occupant monitoring information to give an optimized evacuation plan. Chinese patent application publication number CN1412723A entitled “Intelligent Evacuation Indication and Command and Control System for Fires in Public Site”, discloses using an expert system to give corresponding evacuation plans based on fire alarm location. However, the output quality of expert systems depends on the stored expert experiences in a database, which does not have the flexibility to suit all buildings. Further, the only input to the expert system is fire alarm information that cannot adaptively change with fire development, which weakens the capability of the system to deal with a variety of situations.

In a complicated building environment, traditional fire alarm and evacuation systems cannot provide the evacuees with the situation information, such as maps and layout of the building, fire development status and evacuation directions etc., in an efficient way, causing the evacuees to pursue aimless actions. In traditional evacuation systems, the evacuation directions at different places are indicated through evacuation signs, which are partial and localized information. The information of the whole status of the building, the fire development situations, and the occupant distribution in the building, which are helpful for evacuation decision-making, are lost in the traditional fire alarm and evacuation system. There are no proper approaches in the art to communicate such information, which results in low efficiency of evacuation decision-making.

### SUMMARY OF THE INVENTION

Embodiments of the present invention address issues with traditional fire alarm and evacuation guidance systems, through the use of real-time sensing of information for situation assessment and evacuation guidance.

An exemplary embodiment is a building fire situation awareness and evacuation support system including a plurality of fire monitoring devices for monitoring development of a fire; a plurality of occupant monitoring devices for monitoring occupant distribution in different zones of the building; and a computation device in communication with the fire monitoring devices and occupant monitoring devices, the computation device estimating fire source location and a fire development trend in response to the fire monitoring devices and estimating occupant distributions in different zones of the building in response to the plurality of occupant monitoring devices; the computation device generating an evacuation strategy for occupants in response to the fire monitoring devices, occupant monitoring devices, estimated fire source location, estimated fire development trend, estimated occupant distributions and building structure information; wherein the evacuation strategy includes evacuation routes or evacuation directions.

These and other advantages and features will become more apparent from the following description taken in conjunction with the drawings.

### BRIEF DESCRIPTION OF DRAWINGS

The above described or additional benefits and advantages of the present invention will become more evident though the following drawings which will help to describe exemplary embodiments, where:

FIG. 1 depicts an overall system architecture for one embodiment of the present invention;

FIG. 2 depicts an example monitoring system setup for one embodiment of the present invention;

FIG. 3 depicts an example human-machine interface for one embodiment of the present invention; and

FIG. 4 depicts an example structure of a building fire situation awareness and evacuation support system for one embodiment of the present invention.

### DETAILED DESCRIPTION OF THE PREFERRED EMBODIMENTS

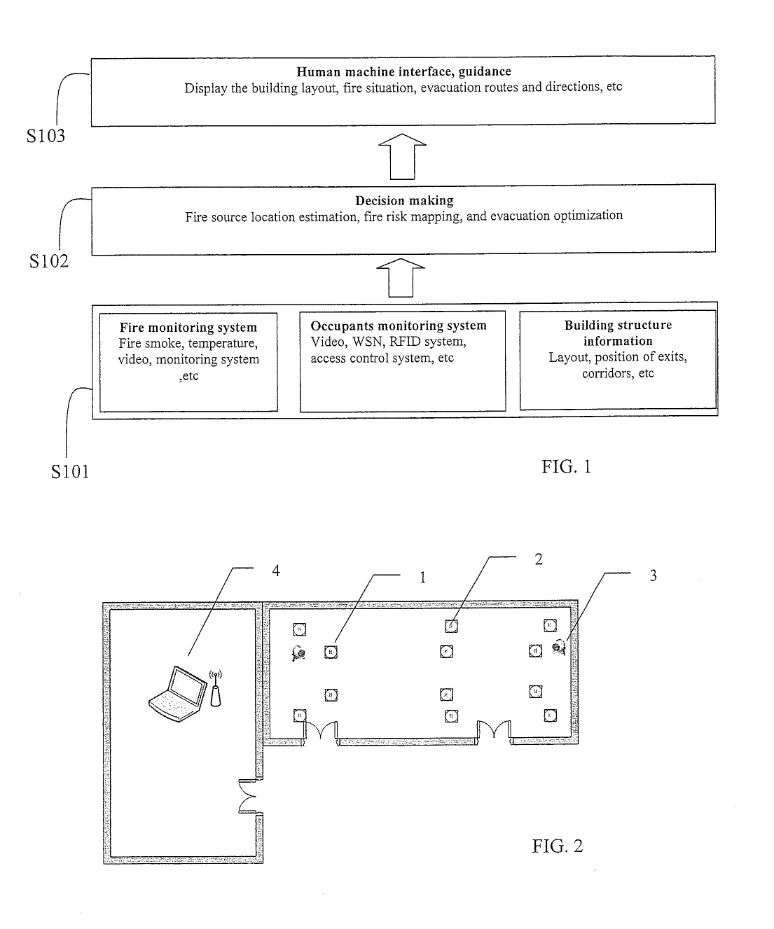

FIG. 1 depicts an overall structure of embodiments of a building fire situation awareness and evacuation support method and system. The building fire situation awareness and evacuation support system and method is arranged in three stages. A first stage, S101, involves monitoring the fire, monitoring the occupants, and acquiring the building structure information. In one embodiment of the present invention, one or more of smoke sensors, temperature sensors and a video system, are used to gather the fire development information. For example, smoke sensors are used to provide the location of the fire source, and temperature sensors are used to estimate the intensity of the fire. Alternatively or additionally, a video system may be used to provide both the location and intensity of the fire. Further, any combination of smoke sensors, temperature sensors and a video system may be employed. Other embodiments of the present invention may also use other sensors such as radiation or hazardous gas sensors to detect or monitor the fire. Accordingly, embodiments are not limited to only the sensors recited herein. In one embodiment of the present invention, as shown in FIG. 2, smoke sensors and temperature sensors are used for monitoring the fire. The installation shown in FIG. 2 includes a plurality of RFID readers 1, a plurality of smoke and temperature sensors 2, a plurality of video cameras 3, and a computation and display device 4 installed in a central control room.

When a fire occurs, the smoke sensors and temperature sensors gather the smoke and temperature information, and send the gathered smoke data and temperature data into the computation device 4, which can be a computer or portable computational terminal such as a PDA.

In one embodiment of the present invention, the system uses one or more of an RFID system, building access control system, wireless sensor network (WSN) and a video system to acquire occupant location information in different zones. For example, in one embodiment of the present invention, a combination of an RFID system and a video system is used to track the location of different occupants. The installed RFID readers can read the RSSI (Received Signal Strength Indicator) and estimate the distance between active RFID tags and readers. Using at least three RFID readers can give an estimation of the location of the RFID tags, to locate occupants carrying RFID tags, and acquire position information for occupants in the buildings. At the same time, the installed video system can also monitor the position of occupants, and through predefined coordination mapping functions, the location of the occupants can be given. Both the RFID system and video system have estimation errors. By sharing information between the two systems, more reliable location estimation results can be generated.

In one embodiment of the present invention, building structure information includes the layout of the different floors of the buildings, the distribution of the corridors and the exits, which are stored in the system.

Stage S102 includes using fire-sensing information to estimate fire location, fire intensity and fire development situation. Stage S102 also includes using occupant location information to estimate an occupant distribution, such as, occupant density in different zones in the building. Stage S102 includes optimizing the evacuation routes and directions for every occupant in the building based on the information of the fire location, fire intensity, and fire development situation, and the information of the occupant distribution, and the information of the building structure.

In one embodiment of the present invention, the computation unit 4 estimates the fire development speed, and coupled with fire models, estimates the fire locations to calculate the fire risk distributions in the building. The fire risk is the non-linear mapping of the temperature measurements, smoke alarms and estimated fire source location probability distribution functions, in which the mapping function can be fitted by test data under specified situations.

In other embodiments of the present invention, computation device 4 can also take the temperature, radiation, hazardous gas and other quantities as criteria for more rigorous risk level estimation, and provide the evacuees and first responders with more information, or input this data to other decision support modules for more efficient decision-making.

In one embodiment of the present invention, the system is integrated with the building security system, and provides a feasible solution to form an integrated system, and improve the safety performance of buildings.

In one embodiment of the present invention, the system calculates the risk distributions in the building, and estimates the congestion levels for different areas in the buildings. Using the risk distribution and the congestion levels to weight the different areas of the buildings, a shortest weighted path can be given utilizing the different locations of exits.

At stage S103, the information of fire location, fire intensity, fire development trend, occupant density, occupant location, optimized evacuation direction and evacuation routes are displayed through human-machine interfaces. FIG. 3 shows an interface of the system for one embodiment of the present invention, in which, 110 indicates the fire monitoring information (e.g., temperature), 120 indicates the occupant information, 130 indicates the estimated probability distribution function for fire location, 140 indicates the estimated probability distribution function for fire intensity, 150 indicates the risk distribution in the buildings, 160 indicates the optimized evacuation direction, and 170 indicates the optimized evacuation routes for different evacuees. Utilizing embodiments of the present invention improves the efficiency of evacuation decision-making. By providing the evacuees with comprehensive fire situation and evacuation information, embodiments of the invention are not restricted to simple evacuation signs and emergency information broadcasting systems, so as to improve the efficiency of evacuation.

In embodiments of the present invention, the system can also send one or several kinds of information, including the information of fire location, fire intensity, fire development situations, and the locations for the trapped people in buildings, to a command and control system of a firefighting department or other first responders. This allows the first responders to know more about the fire and occupant information within the building, so as to improve the efficiency of the firefighting and rescuing.

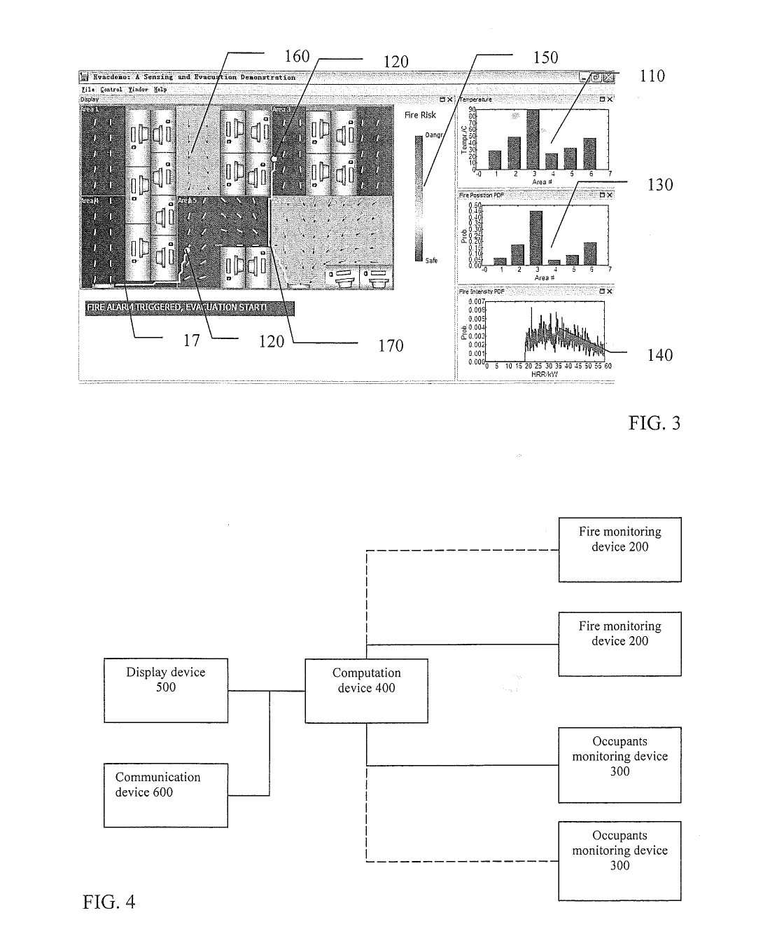

FIG. 4 illustrates a system structure of an embodiment of the building fire situation awareness and evacuation support system. The system includes a plurality of fire monitoring devices 200, a plurality of occupant monitoring devices 300, and computation device 400. In the system, fire-monitoring devices 200 acquire the real-time fire information, which can include one or more of smoke sensors, temperature sensors and a video system. The occupant monitoring system 300 can acquire the location information of occupants in buildings, which can include one or more of RFID systems, access control systems, wireless sensor networks, and video surveillance systems. Computation device 400 can communicate with the fire monitoring devices 200 and occupant monitoring devices 300, using wired or wireless communication, or a combination of wired and wireless communication. For example, part of the information from fire monitoring devices 200 and/or occupant monitoring devices 300 is transferred though wired communication channels, and remaining information is transferred to computation device 400 though wireless communication channels. The particular communication implementations will vary depending on the different situations. The computation device 400 can optimize the evacuation directions and evacuation routes based on the information of fire source locations, fire source intensities, and fire development trends, and the information of occupant distribution in the buildings, including the occupant density and occupant locations.

In one embodiment of the present invention, the system also includes display devices 500, which can display the information of fire source location, fire intensity, fire development trends, occupant density, occupant location, optimized evacuation routes and evacuation directions. The display devices 500 can be installed on portable devices, or on facilities installed in the buildings, such as in corridors or in the emergency control room.

In one embodiment of the present invention, the system also includes communication devices 600, which can communicate with command and control systems used by the fire department, and provide the information of fire source location, fire intensity, fire development trends, and occupant location.

The present invention use state of art technologies of sensing, communication, computation and decision making to provide a feasible solution for a sensing-based evacuation guidance system, which considers the real situation of fires. The system makes use of fire development information and occupant distribution information, and based on evacuation decision-making, generates a real-time updated evacuation plan. Embodiments include intuitive interfaces to provide information for evacuees to provide situation awareness and to reduce the aimlessness of the evacuation, improving safety performance of buildings.

Embodiments of the invention can not only be used for evacuation guidance, but also may be expanded to connect with command and control systems used by the firefighting department, and support the firefighting and rescue tasks. For the fire department, information of fire source location, fire intensity and fire development trends is critical information during their attack of a fire and rescue for trapped occupants. Providing the fire department with this information can improve the efficiency of firefighting and rescuing.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described features in the embodiments. Accordingly, the invention is not to be seen as limited by the foregoing description, but is only limited by the scope of the appended claims

What is claimed is:

1. A building fire situation awareness and evacuation support system comprising:
a plurality of fire monitoring devices for monitoring development of a fire;
a plurality of occupant monitoring devices for monitoring occupant distribution in different zones of the building; and
a computation device in communication with the fire monitoring devices and occupant monitoring devices, the computation device estimating fire source location and a fire development trend in response to the fire monitoring devices and estimating occupant distributions in different zones of the building in response to the plurality of occupant monitoring devices;
the computation device generating an evacuation strategy for occupants in response to the fire monitoring devices, occupant monitoring devices, estimated fire source location, estimated fire development trend, estimated occupant distributions and building structure information;
wherein the evacuation strategy includes evacuation routes or evacuation directions.

2. The building fire situation awareness and evacuation support system of claim 1 further comprising:
a display device for displaying fire source location, fire intensity, fire development trend, occupant density, occupant location, evacuation directions and evacuation routes through a human-machine interface.

3. The building fire situation awareness and evacuation support system of claim 2 wherein:
the display device includes at least one of portable communication devices of evacuees, portable communication devices of first responders, and displays installed in the building.

4. The building fire situation awareness and evacuation supporting system of claim 1 wherein:
the fire monitoring system include at least one of smoke detectors, temperature sensors and a video system.

5. The building fire situation awareness and evacuation supporting system of claim 1 wherein:
the occupant monitoring system includes at least one of an RFID system, an access control system, a wireless sensor network and a video system.

6. The building fire situation awareness and evacuation support system of claim 1 wherein:
the computation device calculates a risk distribution based on fire source location, fire intensity and fire development trend.

7. The building fire situation awareness and evacuation support system of claim 1 further comprising:
a communication device for sending at least one of fire location, fire intensity, fire development trend and occupant distribution to a command and control system of a fire department.
